(19) United States
(12) Patent Application Publication
(10) Pub. No.: US 2026/0001370 A1
(43) Pub. Date: Jan. 1, 2026

(54) Side-Loading Graded Card Binder for PSA Cards

(71) Applicant: Raymond Ich Tham, Beaumont (CA)

(72) Inventor: Raymond Ich Tham, Beaumont (CA)

(21) Appl. No.: 18/758,045

(22) Filed: Jun. 28, 2024

(51) Int. Cl. B42F 5/04

(52) U.S. Cl. CPC B42F 5/04; B42P 2241/20

(57) ABSTRACT

This invention pertains to a specially designed binder for storing PSA-graded cards, offering a unique side-loading feature for added security and convenience. The binder, crafted from premium PU leather with a brand logo “FunGuys,” integrates a sophisticated design that includes a soft microfabric interior and clear PP plastic individual pages. Each page, designed to hold six PSA-graded cards, features a rubber zipper branded with FunGuys/Ultra-Guard. The innovation is the side-loading mechanism of the binder—with the first and second columns of each page loading to the left and the third column loading to the right—enhancing card protection and preventing accidental sliding out. The binder accommodates up to 60 PSA-graded cards across ten individual pages. This invention distinctly contrasts with top-loading binders available in the market, which use different material compositions, and do not offer the same level of design sophistication tailored specifically for PSA-graded cards.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

This invention pertains to the field of protective storage devices for collectible cards, specifically a binder designed to securely hold PSA-graded cards or other similarly sized graded cards. This invention pertains to the fields of collectible protection, organizational tools, and premium storage solutions.

### Description of the Related Art

Collectible card games and sports trading cards have surged in popularity, making them valuable commodities both for recreational collectors and serious investors. PSA, or Professional Sports Authenticator, is one of the foremost authorities in card grading, providing a numerical grade that certifies a card's condition, rarity, and overall value. These grades are encased in tamper-evident holders, increasing the intrinsic and market value of the cards. As the demand and value for PSA-graded cards escalate, so does the need for adequate storage solutions. Conventional methods like simple binders or storage boxes often lack the requisite features to protect such high-value collectibles adequately. The inadequacies of existing solutions create a strong demand for advanced, specialized storage options.

The importance of proper storage for PSA-graded cards cannot be overstated. Any damage, exposure to dust, or improper handling can severely affect a card's condition and, subsequently, its value. Collectors and investors alike seek solutions that offer premium protection, easy organization, and aesthetic appeal. High-value items like PSA-graded cards deserve storage options that reflect their worth, combining safety features with a design that offers convenience and showcases the collection elegantly. This confluence of security and presentation is crucial for maintaining and potentially increasing the value of the cards over time.

The collectible card market has experienced exponential growth in recent years. According to industry reports, the market size for trading cards, including sports cards, is projected to exceed $98 billion globally by 2027. PSA alone has graded over 30 million cards, and this number continues to rise. Some PSA-graded cards, particularly rare or vintage ones, have been auctioned for prices well over $1 million. For example, a PSA-graded Mickey Mantle card sold for $5.2 million in 2021. Such staggering figures highlight the significant financial implications of proper card storage and underline the necessity for specialized, high-quality solutions that protect these valuable assets.

Currently, the market is deficient in offering a dedicated storage binder tailored specifically for graded cards. While collectors of other types of trading cards, such as those encased in top loaders or standard trading cards, have a plethora of storage options, graded card collectors face a significant void. Several companies have recognized this gap and made attempts to penetrate the market with solutions such as top-loading binders, plastic pocket pages, and standard trading card binders. Despite these ventures, many products lack the essential innovation required to meet the specific needs of graded card collectors. Predominantly, the flaws in these products stem from incorrect sizing and dimensions that do not accommodate the thicker and larger graded cards. Additionally, the card loading styles are often not user-friendly, making it challenging to insert and remove cards without potential damage. Furthermore, these storage solutions frequently fall short in providing adequate accessibility and security, which are crucial for preserving the condition of valuable graded cards. Consequently, the current offerings do not sufficiently address the practical and protection needs of graded card collectors, leaving a substantial gap in the market.

The proposed invention presents a superior storage solution for PSA-graded cards, tailored to meet the needs of even the most discerning collectors. The binder features a high-quality PU leather exterior, embossed with the “FunGuys” brand logo, offering both durability and sophistication. Inside, the binder is lined with soft microfabric material, ensuring that the enclosed cards are cushioned against any potential abrasion or impact. The pages are constructed from clear PP (polypropylene) plastic, chosen for its archival safety, chemical inertness, and clarity. A key innovation is the side-loading design of the slots, which secures the cards more effectively than traditional top-loading designs and provides robust protection against dust and debris. Each binder can hold up to 60 PSA-graded cards, organized across ten individual pages with 6 individual slots each featuring a dimension of W: 9.6×H: 14.6 cm.

This invention is crafted to enhance both the protection and display of PSA-graded cards. The side-loading mechanism is a distinctive feature that mitigates the risk of cards accidentally slipping out and reduces their exposure to dust. This design fundamentally improves the security and longevity of valuable cards. The use of premium materials like PU leather and clear PP plastic ensures that the binder is not only durable but also resistant to wear and tear, delivering archival safety. The binder's capacity and organizational features allow collectors to efficiently categorize and access their cards, providing a streamlined user experience. The robust rubber zipper, embossed with the FunGuys/Ultra-Guard logo, further enhances security, while also offering ease of use and contributing to the binder's aesthetic appeal.

Each page in the binder includes reinforced edges to prevent tearing, enhancing the product's longevity. The transparent, high-clarity plastic pages ensure that details of each graded card are visible without the need to remove them from their protective sleeves. The binder's cover and spine are padded for additional protection against drops and impacts, ensuring that the cards inside remain unharmed. The robust rubber zipper effectively seals the binder, preventing dust, moisture, and other environmental factors from compromising the stored cards. This combination of elements underscores the binder's role as a comprehensive protective solution for PSA-graded cards. The binder is lightweight and portable, making it easy for collectors to transport their collections to trade shows, meetings, or any other location.

The proposed invention also prioritizes aesthetic appeal to meet the preferences of high-end collectors. The exterior of the binder is made from premium PU leather, offering a sophisticated look and feel. The embossed “FunGuys” brand logo adds a touch of elegance and exclusivity. Collectors can choose from various colors of interior microfabric and the zipper lining to suit their personal tastes or to match the theme of their collection. The inner lining made from soft microfabric not only protects the cards but also adds to the luxurious feel of the binder. This blend of functionality and visual appeal ensures that the binder will be a cherished item among collectors, adding value to their overall collection experience.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The present invention seeks to improve upon prior techniques and provide an advanced methodology of the binder for storing PSA-graded cards.

It is the objective of the invention to protect PSA-graded cards from physical damage through the use of reinforced, durable materials in both the binder cover and individual pages.

Another objective of the present invention is to prevent accidental slippage of cards by utilizing side-loading slots that secure PSA-graded cards more effectively and offer easier accessibility compared to traditional top-loading designs.

It is also an object of the invention to offer a high-capacity storage solution that holds up to 60 PSA-graded cards, allowing collectors to organize a significant portion of their collection in one compact binder.

It is further the objective of the invention to enhance the aesthetic appeal of card storage by using premium PU leather, combined with an embossed brand logo.

It is also the objective of the invention to provide long-lasting archival safety by using clear PP plastic pages, which are chemically inert and resistant to yellowing and degradation over time.

It is also the objective of the invention to ensure the easy accessibility and viewing of cards through transparent, high-clarity plastic pages that showcase the detailed features of each graded card.

It is also the objective of the invention to minimize the ingress of dust and debris with a rubber zipper closure, thereby maintaining the pristine condition of the stored cards.

Thus, it is the objective to provide a new and improved form of a portable and secure storage solution with a robust, weather-resistant exterior and a locking zipper mechanism, ensuring safe transport and protection against environmental elements.

This Summary is provided merely for the purposes of summarizing some example embodiments, providing a basic understanding of some aspects of the subject matter described herein. Accordingly, it will be appreciated that the above-described features are merely examples and should not be construed to narrow the scope of the subject matter described herein in any way. Other features, aspects, and advantages of the subject matter described herein will become apparent from the following Detailed Description, Figures, and Claims.

### DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 illustrates side view of the proposed assembly, as per an embodiment of the present disclosure.

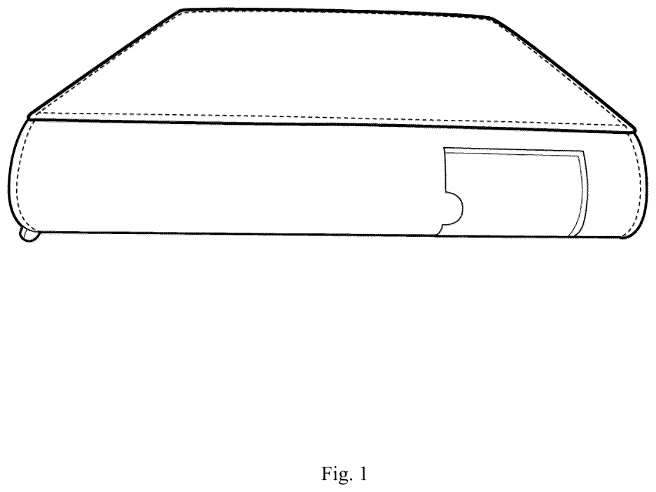

FIG. 2 illustrates a top view of the present invention, per an embodiment of the present disclosure.

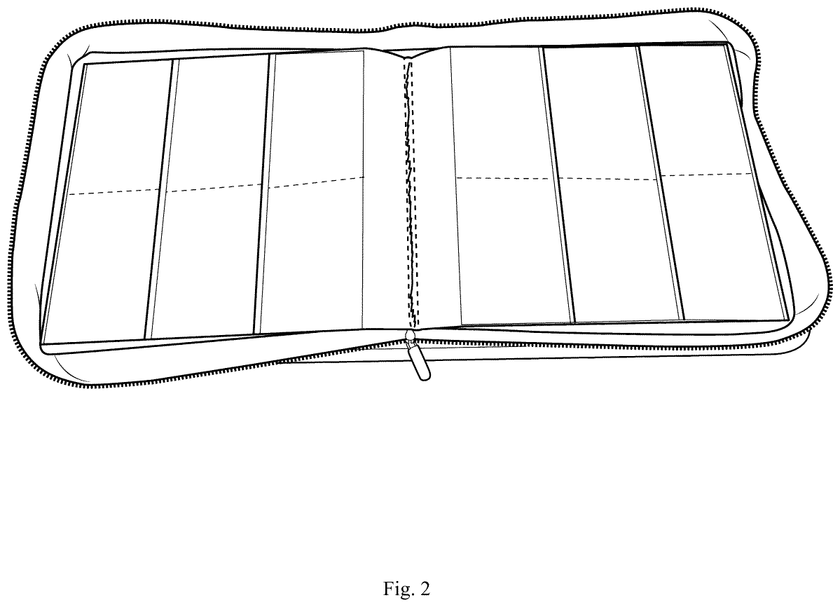

FIG. 3 illustrates the back view of the assembly per an embodiment of the present disclosure.

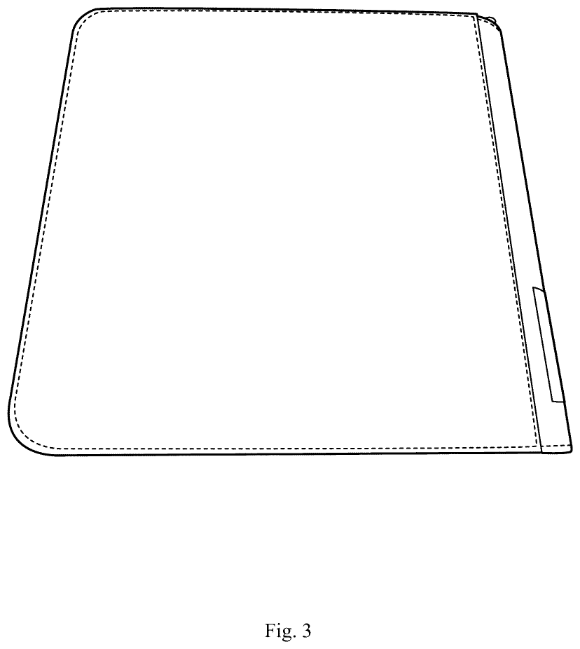

FIG. 4 illustrates the inner view of the assembly per an embodiment of the present disclosure.

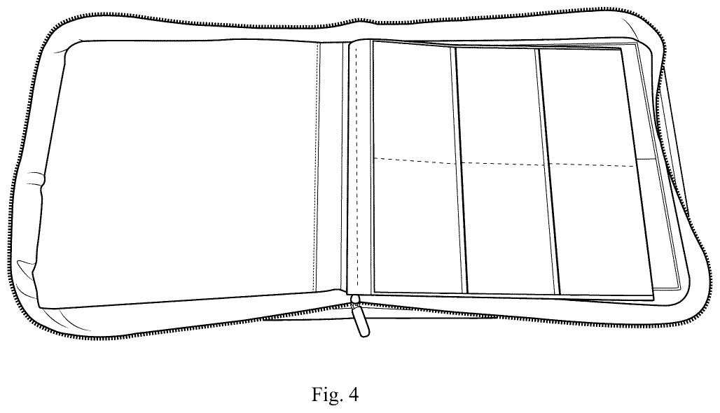

FIG. 5 illustrates another side view of the assembly per an embodiment of the present disclosure.

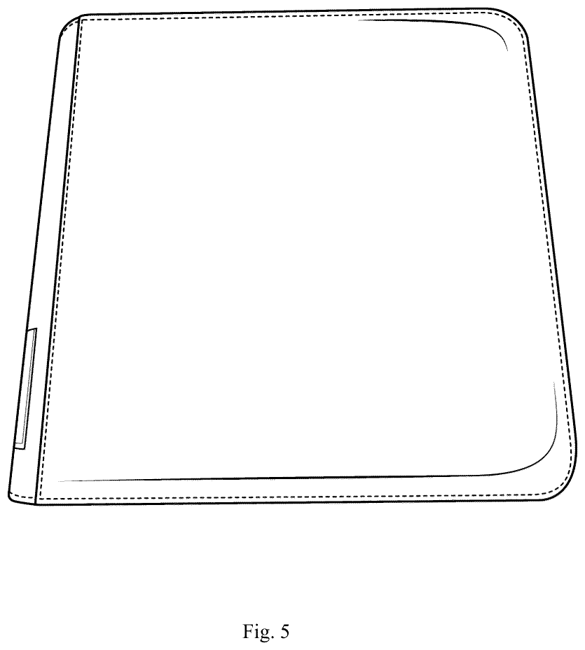

FIG. 6 illustrates another inner view of the assembly per an embodiment of the present disclosure.

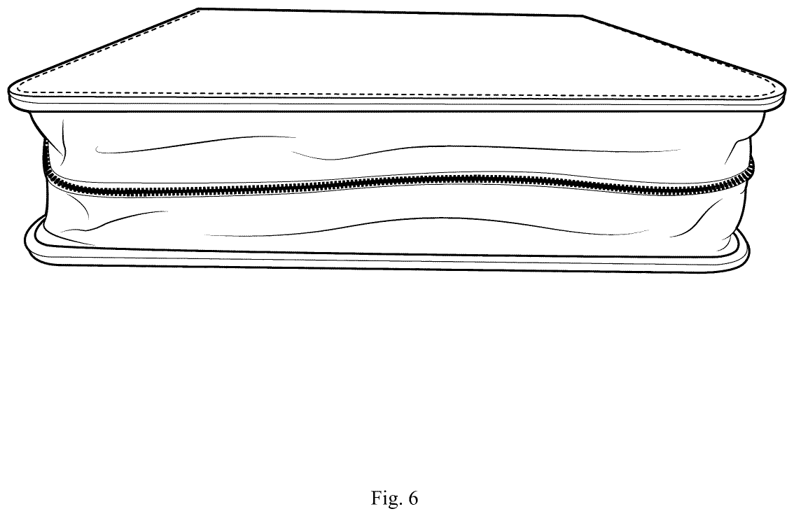

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention relates to storage solutions specifically designed for collectors of PSA-graded cards. PSA, or Professional Sports Authenticator, is a leading third-party grading service for trading cards, which assigns a grade to each card based on its condition. These graded cards are housed in durable, tamper-evident cases that add significant value to the collectibles. As such, there is a critical need for storage solutions that not only protect these valuable assets but also provide convenient access and organization. This invention fulfills this need by introducing a high-end binder specifically tailored for PSA-graded cards, featuring side-loading slots, premium materials, and a robust structure.

As per its preferred embodiments, the binder's construction begins with an exterior cover made from premium PU (polyurethane) leather. The choice of PU leather is driven by its combination of durability, flexibility, and aesthetic appeal. Unlike genuine leather, PU leather is resistant to scratches, cracks, and environmental wear, making it ideal for a product designed for frequent handling. The exterior not only serves as a protective layer but also adds a sophisticated touch with the brand logo “FunGuys” embossed on the front cover, reinforcing the brand identity and appealing to high-end collectors.

As per its preferred embodiments, the interior of the binder is lined with a soft microfabric material, selected for its cushioning properties. This fabric ensures that the PSA-graded cards housed within the binder are shielded from any abrasive contact that could potentially mar the surfaces of the card cases. The microfabric lining is also anti-static, reducing the attraction of dust and other particulate matter, contributing to the long-term preservation of the cards. This attention to detail underscores the focus on both protective features and a premium user experience.

As per its preferred embodiments, the standout feature of this binder is its individual pages, constructed from clear PP (polypropylene) plastic. PP plastic is known for its clarity, robustness, and chemical inertness, making it an excellent choice for archival safety. Each page within the binder is designed to hold six PSA-graded cards, arranged in a W: 9.6×H: 14.6 cm. This configuration optimizes space while ensuring each card is easily viewable and accessible. The clear PP pages provide a transparent view of the cards without any color distortion, allowing collectors to appreciate the details of their graded cards fully.

As per its preferred embodiments, the innovation of side-loading slots distinguishes this binder from traditional top-loading designs. Each page features six slots, offering several advantages. Primarily, the side-loading approach reduces the risk of cards inadvertently slipping out, a common issue with top-loading pages. Additionally, side-loading slots are more effective at preventing dust and debris from entering, as the cards are protected. This design ensures that cards remain securely in place, preserving their pristine condition.

As per its preferred embodiments, the binder is engineered to hold up to 60 PSA-graded cards, distributed across ten individual pages. This capacity strikes a balance between accommodating a sizable collection and maintaining a manageable, portable form factor. Each page, with its six slots, offers intuitive organization, allowing collectors to categorize their cards in various ways—whether by theme, series, or value. The clear PP pages are both sturdy and flexible, ensuring that they do not become brittle over time, thus offering reliable, long-term use.

As per its preferred embodiments, beyond the unique side-loading slots, the binder incorporates several advanced protective features. Each slot within the pages has reinforced edges to prevent tearing and extended durability. The pages are also designed with a robust spine to prevent warping or bending, which could compromise the binder's structural integrity over time. Additionally, the binder is equipped with a rubber zipper featuring the FunGuys/Ultra-Guard logo. This zipper is designed for endurance, providing smooth operation even with frequent use, adding an extra layer of security.

As per its preferred embodiments, the key advantage of this binder is its versatility in aesthetic and functional options. Collectors can choose from a range of colors, catering to various personal preferences and enhancing the appeal of the product. This customization extends the binder's utility and desirability among diverse collector demographics.

As per its preferred embodiments, the graded card binder offers a superior solution for PSA-graded card storage, combining innovative design features with high-quality materials to provide optimal protection, convenience, and aesthetic appeal for collectors.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its scope. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A binder for storing PSA-graded cards, comprising:
An exterior cover made of PU premium leather featuring a brand logo, Interior lining composed of soft microfabric material.
A plurality of individual pages made of clear PP plastic, each page containing six slots.
A rubber zipper with an attached FunGuys/Ultra-Guard logo.
The binder of claim 1, wherein the exterior PU premium leather cover includes a weather-resistant coating.
The binder of claim 1, wherein the soft microfabric material interior lining provides cushioning to further protect the graded cards.
The binder of claim 1, wherein the clear PP plastic individual pages are acid-free and archival-safe to prevent any potential damage to the cards.
The binder of claim 1, wherein the rubber zipper with the logo designed to withstand frequent usage without degrading in quality.
The binder of claim 1, wherein each individual page is reinforced with a durable spine to prevent bending or warping over time.
The binder of claim 1, wherein the side-loading slots have reinforced edges to prevent tearing during insertion and removal of the PSA-graded cards.
The binder of claim 1, wherein each slot is dimensioned to fit closely around PSA-graded cards to prevent movement within the slot.
The binder of claim 1, wherein the rubber zipper acts as a feature to fully secure and prevent accidental openings.
The binder of claim 1, wherein the clear PP plastic pages are individual one-sided-side loading, allowing for insertion of graded cards.
The binder of claim 1, wherein the side-loading design reduces the risk of dust and debris entering the slots.
The binder of claim 1, wherein the binder comprises a body made from a uniquely thick and sturdy cardboard material.
The binder of claim 1, wherein the cardboard is significantly stronger than that used in competing brands, characterized by its exceptional rigidity and resistance to bending ensuring superior quality and durability, distinguishable by the tactile difference when compared to other binders.
The binder of claim 1, wherein the design and materials collectively provide shock-absorbent properties to protect the contents from impact damage.

2. The binder has slots are designed to hold PSA-graded cards securely by providing side-loading entry to prevent accidental slippage and protect the cards from damage.

3. The binder further comprises a total binder capacity to hold up to 60 PSA-graded cards, with ten individual pages, each page having six slots designed for side-loading insertion.
